(19) United States
(12) Patent Application Publication
(10) Pub. No.: US 2019/0362577 A1
(43) Pub. Date: Nov. 28, 2019

(54) SECURE CONTAINER FOR RECEIVING DELIVERIES

(71) Applicant: STAND GUARD, LLC, Denver, CO (US)

(72) Inventor: Phil Vigil, Denver, CO (US)

(21) Appl. No.: 16/420,690

(22) Filed: May 23, 2019

Related U.S. Application Data
(60) Provisional application No. 62/675,441, filed on May 23, 2018.

(51) Int. Cl. G07C 9/00; G06K 7/14; G06Q 10/08

(52) U.S. Cl. CPC G07C 9/00896; G06K 7/1413; G07C 2009/0092; G06Q 10/0832; G07C 9/00103; G06K 7/1417

(57) ABSTRACT

Implementations described herein disclose a secure container for receiving deliveries. Specifically, the secure container disclosed herein is equipped with communication technology, such as WiFi, Bluetooth, or other appropriate communication method to communicate with consumers, with mobile devices, with delivery company, and with eCommerce provider about the safe receipt of packages from the delivery company.

### CROSS-REFERENCE TO RELATED APPLICATIONS

This application is a non-provisional application of and claims benefit of U.S. Provisional Application Ser. No. 62/675,441 entitled “SECURE CONTAINER FOR RECEIVING DELIVERIES” and filed on May 23, 2018 which is incorporated herein by reference in its entirety.

### BACKGROUND

In modern society, eCommerce has become a highly integral part of how people purchase a large array of things. With the daily hectic routines and availability of almost every item online, the need for consumers to go to stores and buy anything, from daily necessities to specialty items, has been almost eliminated. It is not unusual for a family to receive one or more deliveries at their home at least once or twice a week.

### SUMMARY

Implementations described herein disclose a secure container for receiving deliveries. Specifically, the secure container disclosed herein is equipped with communication technology, such as WiFi, Bluetooth, or other appropriate communication method to communicate with consumers, with mobile devices, with delivery company, and with eCommerce provider about the safe receipt of packages from the delivery company.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

A further understanding of the nature and advantages of the present technology may be realized by reference to the figures, which are described in the remaining portion of the specification. In the figures, like reference numerals are used throughout several figures to refer to similar components.

FIG. 1 illustrates an example isometric view of a secure container for receiving deliveries for consumers.

FIG. 2 illustrates an example front view of the secure container for receiving deliveries for consumers.

FIG. 3 illustrates an example back view of the secure container for receiving deliveries for consumers.

FIG. 4 illustrates example side views of the secure container for receiving deliveries for consumers.

FIG. 5 illustrates an example flowchart of one or more operations for using the secure container for receiving deliveries for consumers.

FIG. 6 illustrates an alternative example flowchart of one or more operations for using the secure container for receiving deliveries for consumers.

FIG. 7 illustrates an example block diagram of various components of a system using the secure container for receiving deliveries for consumers.

FIG. 8 illustrates a screen shot of a graphical user interface (GUI) for using the application disclosed herein.

FIG. 9 illustrates a screen shot of a graphical user interface (GUI) for using the application disclosed herein.

FIG. 10 illustrates an alternative mounting bracket design of the container disclosed herein.

FIG. 11 illustrates an alternative accordion style design of the container.

FIG. 12 illustrates an example computing system that may be useful in implementing the described technology of secure container for receiving deliveries.

FIG. 13 illustrates an example mobile device that may be useful in implementing the described technology of secure container for receiving deliveries.

### DETAILED DESCRIPTIONS

A secure container for receiving deliveries disclosed herein allows consumers to receive deliveries of packages in a secure manner.

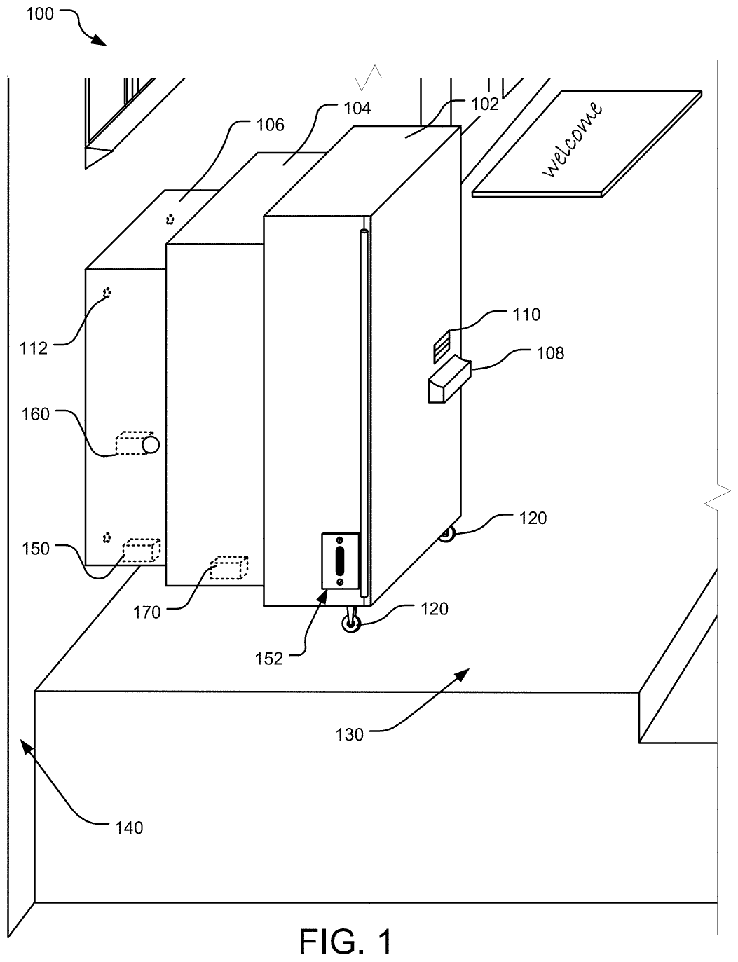

FIG. 1 illustrates an isometric view of a secure container 100 for receiving deliveries for consumers. The secure container 100 may be configured so that it can be installed on a porch 130 or other area of a consumer's house. For example, as illustrated, the secure container 100 is affixed to a wall 140 of a porch. In one implementation, the secure container 100 may have wheels 120 that allows it to be slidably expand or collapse away from the wall 140. The container 100 is illustrated to have an accordion like arrangement with a front chamber 102, a middle chamber 104, and a back chamber 106. Note that in an alternative implementation, fewer or more chambers may be provided. The back chamber 106 may be affixed to the wall 140 of the porch 130 using any fastening mechanism 112, such as screws, etc. In alternative implementations, there will be an additional fit for apartment and townhouse renters to securely strap the container to their front door eliminating the chance of any structural damage to property of actual owner. This strap will be custom to fit original bracket.

The front chamber 102 is provided with wheels 120 such that it can be pulled forward away from the wall 140 or pushed back towards the wall 140. This allows variable size packages to be delivered/stored in the container 100 without it taking up too much space on the porch 130 when it is not in use. The container 100 includes a scanner 108 or other imaging or scanning device affixed to on front of the front chamber 102. A delivery person delivering a package may scan a bar code, a QR-code or other identifier on the package by activating the scanner by pressing a scan button 110. Upon the activation, the scanner 108 takes an image of the identifier on the package and communicates it to a processor 150 installed on the container 100. Alternatively, such processor may be located at another location, such as inside the house, in which case a wireless transmitter that is communicatively connected to the scanner 108 communicates the scanned identifier via such wireless transmitter to the processor.

In one implementation, the secure container 100 generates an alert in response to the scanner 108 scanning a barcode, QR code, etc., that is not an expected or when an unknown or unexpected barcode, QR code, etc., are attempted to be scanned. Furthermore, a locking mechanism 152 of the secure container may be communicatively connected with the processor 150 such that the secure container 100 may be locked in response to a scanning of an unexpected identifier being scanned. The locking mechanism 152 may be a latch that may be communicatively connected to the processor 150 and therefore may receive communications from the consumer's mobile device.

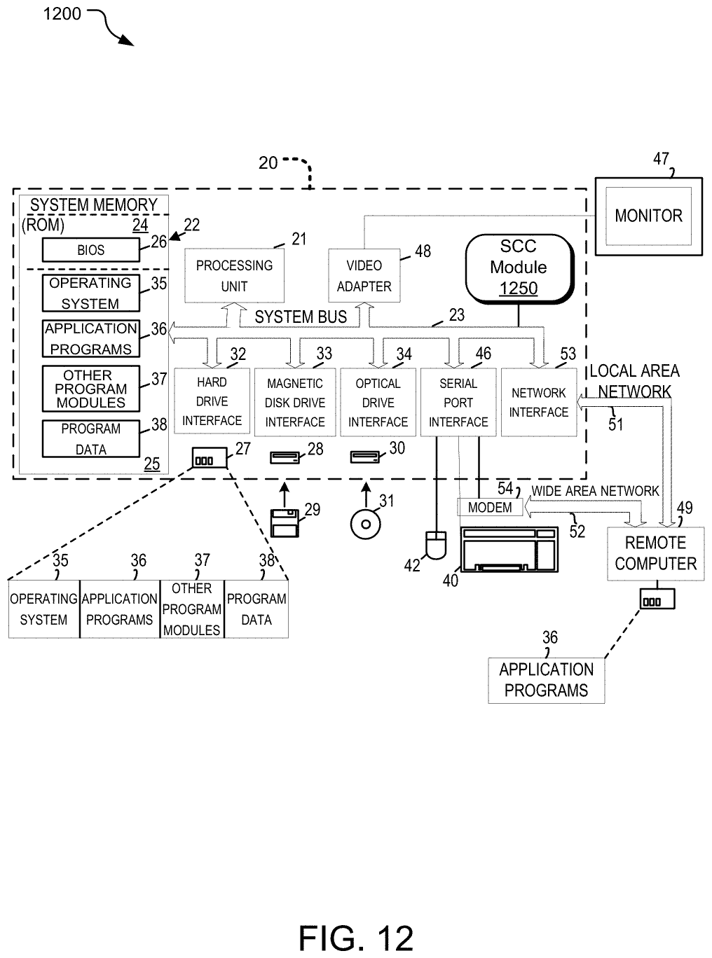

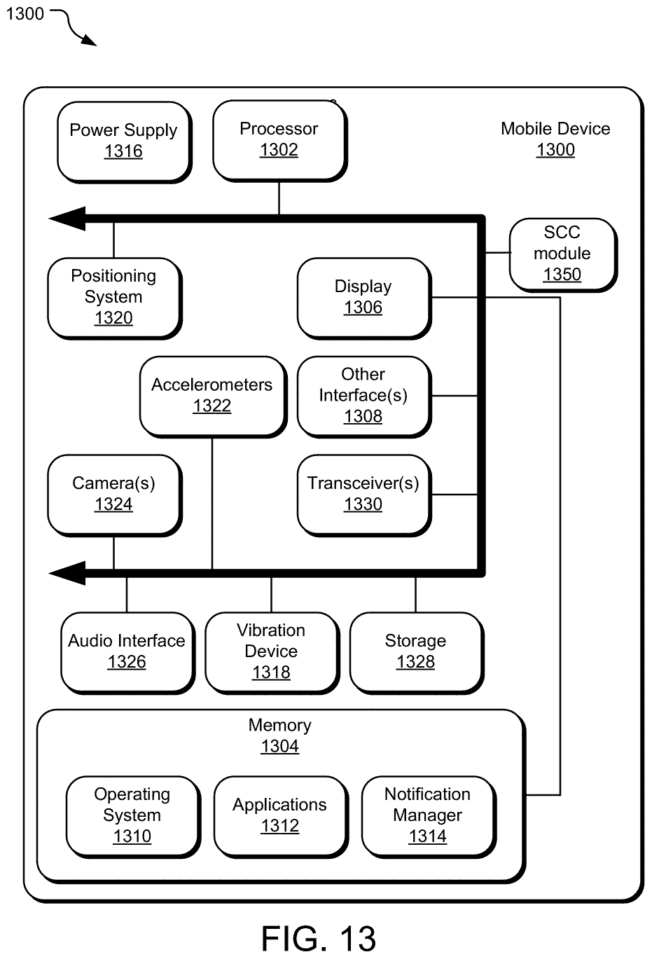

The processor 150 may also be part of a computing device (such as the computing devices disclosed in FIGS. 12 and 13) that includes memory and other components. The processor 150 may compare the identifier with information related to an expected delivery. If there is a match, the front door to the container 100 is opened for a predetermined amount of time. This allows the delivery person to drop the package in the container 100. Once the container 100 is securely locked after accepting the delivery, the transmitter may send a message to the consumer who has purchased the package, an application server that manages an app for delivery of secure packages, an application server for a delivery company, an application server for the eCommerce vendor that sold the package, etc.

The secure container 100 may also include a camera 160 that may be activated in response to receiving delivery of a package to take a picture of the delivered in the secure container 100. For example, once the secure container 100 is closed after the delivery, the camera 160 may take a picture of the package inside the secure container. The camera 160 may be communicatively connected to the processor 150 and one or more wireless communicator in the secure container 100 so that the image can be communicated to a remote server or an application server used to communicate with an app on a user's mobile device. Yet alternatively, the camera 160 may be configured so that it may be activated by the user on demand to see the delivered package.

In an alternative implementation, the secure container 100 may also be provided with a temperature sensor 170 inside the secure container 100. The temperature sensor 170 may be configured to measure the temperature inside the secure container 100 and communicate the measured temperature to the consumer via the wireless communication methodology available to the secure container 100. Thus, if a perishable package, such as food is delivered and it is required to be at certain temperature, the consumer is able to determine that the temperature of the secure container 100 is within a range where the perishable delivered item will not deteriorate. In one implementation, the consumer may set the temperature sensor so that at predetermined time intervals it measures the internal temperature of the secure container 100 and communicates it to the consumer's mobile device.

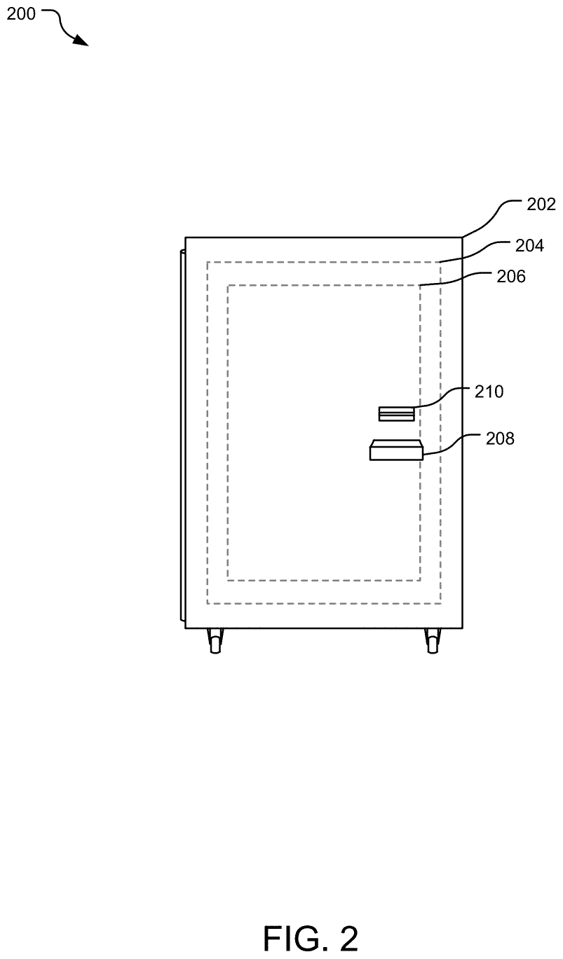

FIG. 2 illustrates a front view 200 of the secure container for receiving deliveries for consumers. Specifically, the front view 200 illustrates a front chamber 202 in the front having a scanner 208 and a button 210 to open the container. The middle chamber 204 and the back chamber 206 are also illustrated.

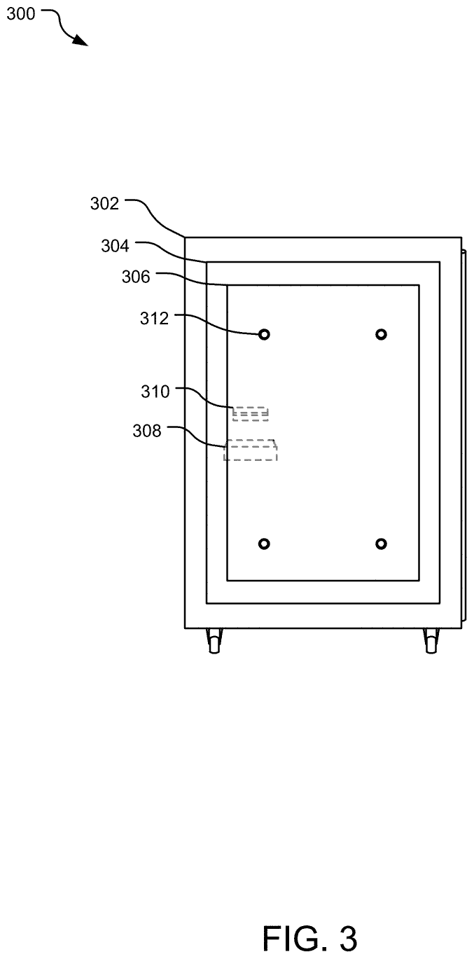

FIG. 3 illustrates a back view 300 of the secure container for receiving deliveries for consumers. Specifically, the back view 300 illustrates a back chamber 306 with fastening mechanism 312 for attaching the container to a wall, a middle chamber 304, a front chamber 302, a scanner 308 located on the front of the front chamber 302 and a button 310 also located on the front of the front chamber 302.

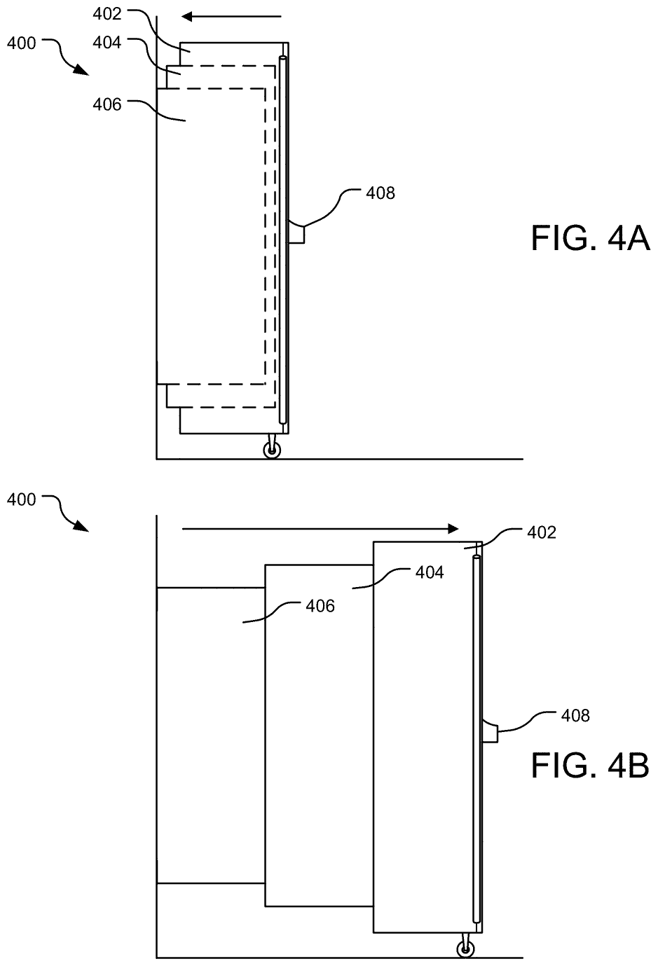

FIG. 4 illustrates side views 400 of the secure container for receiving deliveries for consumers. Specifically, the side views 400 illustrate a back chamber 406, a middle chamber 404, a front chamber 402, and a scanner 408 located on the front of the front chamber 302.

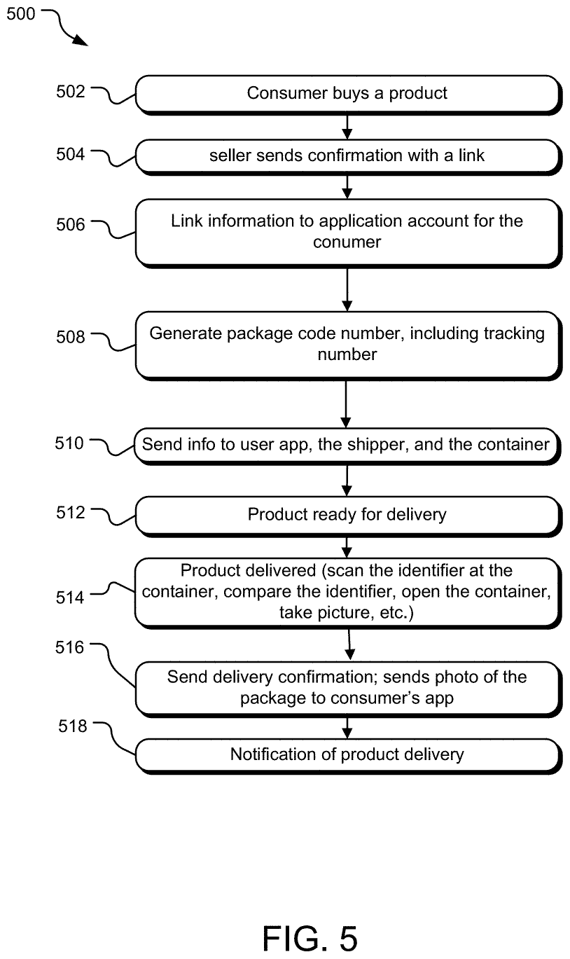

FIG. 5 illustrates a flowchart 500 of one or more operations for using the secure container for receiving deliveries for consumers. A customer buys a product from an online vendor at an operation 502. At operation 504, the seller sends a confirmation with a link to the customer. In an alternative implementation, the operation 504 may automatically update an app used by the customer with the confirmation information. An operation 506 links the information sent by the online vendor with the app, such as a mobile device based app, of the customer to populate information such as the name of the delivery company, the expected delivery date, potentially an identifier such as a bar code, a QR-Code, etc., associated with the delivery package, etc.

At an operation 508, a package code number, a tracking number, etc., are generated. An operation 510 communicates these information to the container, where it may be stored with a processor associated (either directly or via a communication device such as a wireless transmitter) with the container. At operation 512, the product may be ready for delivery and at an operation 514 the product is delivered to the container. The product delivery operation 514 may include the delivery person scanning an identifier (bar code, QR-code) using the scanner on the container, a processor analyzing the identifier and opening the container, receiving the package and closing the door of the container, etc.).

An operation 516 sends the delivery confirmation to the customer's app and to the processor associated with the container. In one implementation, it may also send a photo of the package to the customer's app and to the customer's mobile device. An operation 518 sends a notification of the product delivery to the eCommerce provider, the delivery company, the customer, etc.

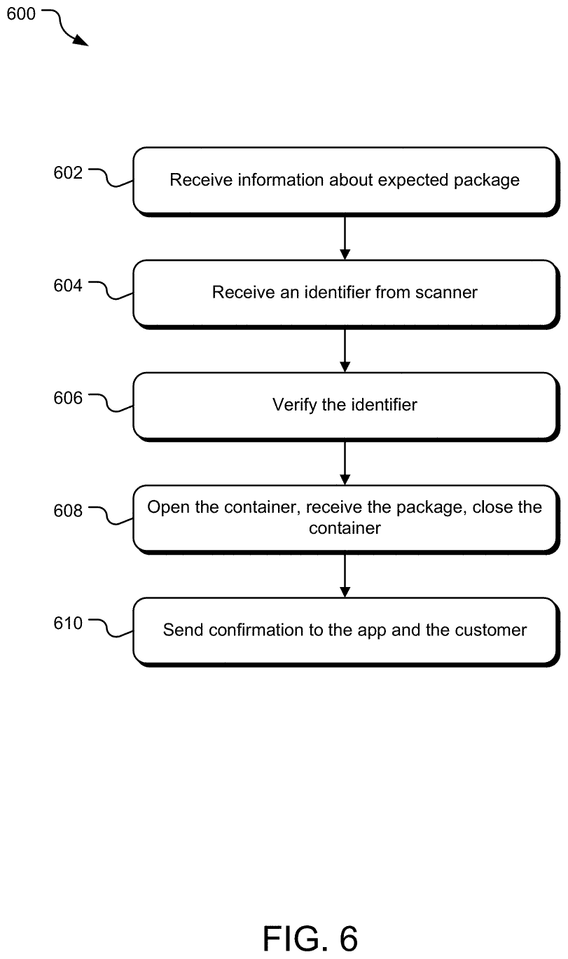

FIG. 6 illustrates an alternative flowchart 600 of one or more operations for using the secure container for receiving deliveries for consumers at the container. The operations of the flowchart 600 may be implemented using a processor associated with the container or located at an alternative location. An operation 602 receives information about an expected package, including expected delivery date, potentially an identifier that will be attached to the package, etc. An operation 604 receives an identifier output from a scanner attached to the container. An operation 606 verifies the identifier and if it is verified, an operation 608 opens the container, receives the package, and securely closes the container. An operation 610 sends a confirmation to the customer and/or to an app used by the customer.

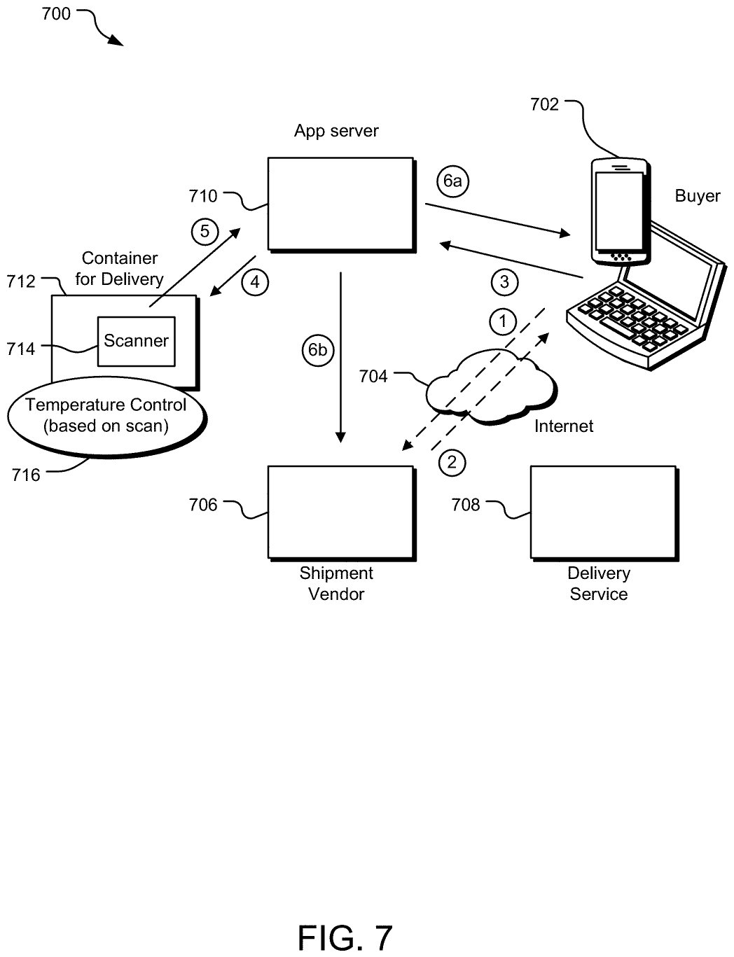

FIG. 7 illustrates a block diagram 700 of various components of a system using the secure container for receiving deliveries for consumers. At operation 1, a customer using a device 702 purchases a product from a vendor 706. And at operation 2, the vendor 706 sends a confirmation to the device 702. At operation 3, the device may send the information about the purchase to an app server 710 that manages the receipt of packages using a container 712. At operation 4, the app server 710 sends this information to the container, which may include a scanner 714 and a temperature control apparatus 716 that manages the temperature of the container based on the information associated with the scanned identifier. For example, if the scanned identifier indicates that the delivered package is food that needs to be maintained at freezer level, the temperature control apparatus 716 may adjust the temperature of the container accordingly.

At operation 5, upon receipt of the package, the container (using a wireless transmitter) may communicate the confirmation to the app server 710. At 6a and 6b the app server may communicate such confirmation to the device 702 (or an app based on that device) and to the vendor 706 (or an app of the vendor that is on the device 702). Each of the various components may communicate with each other using a network, such as the Internet 704. The vendor 706 may communicate various information to a delivery service 708 or its server when the product is ready to be shipped, when the product delivery is confirmed, etc.

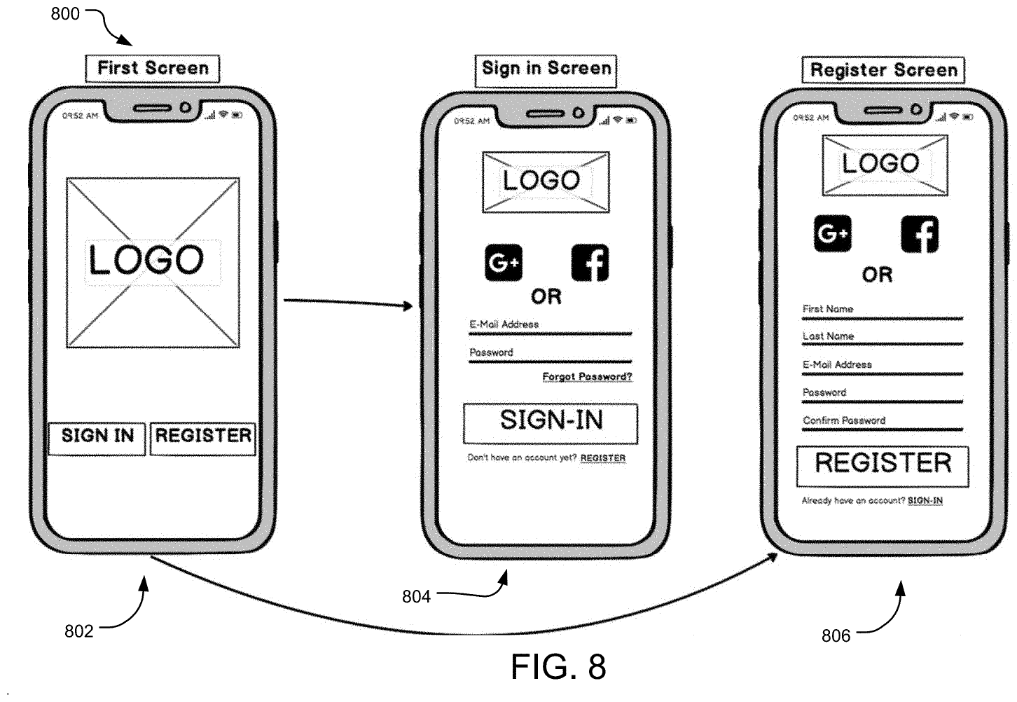

FIG. 8 illustrates a screen shot of graphical user interfaces (GUIs) 800 for using the application disclosed herein. Specifically, at GUI 802 a user may select either to sign-in or register for the app that allows the user to track delivery of goods to the secure delivery container disclosed herein. If the user is already registered, they can sign-in at GUI 804, the user may log-in using their user-id and the password. Alternatively, if the user is new and/or they need to register, they may sue GUI 804 to register for using the app for registering and tracking secure delivery of goods to the secure delivery container disclosed herein.

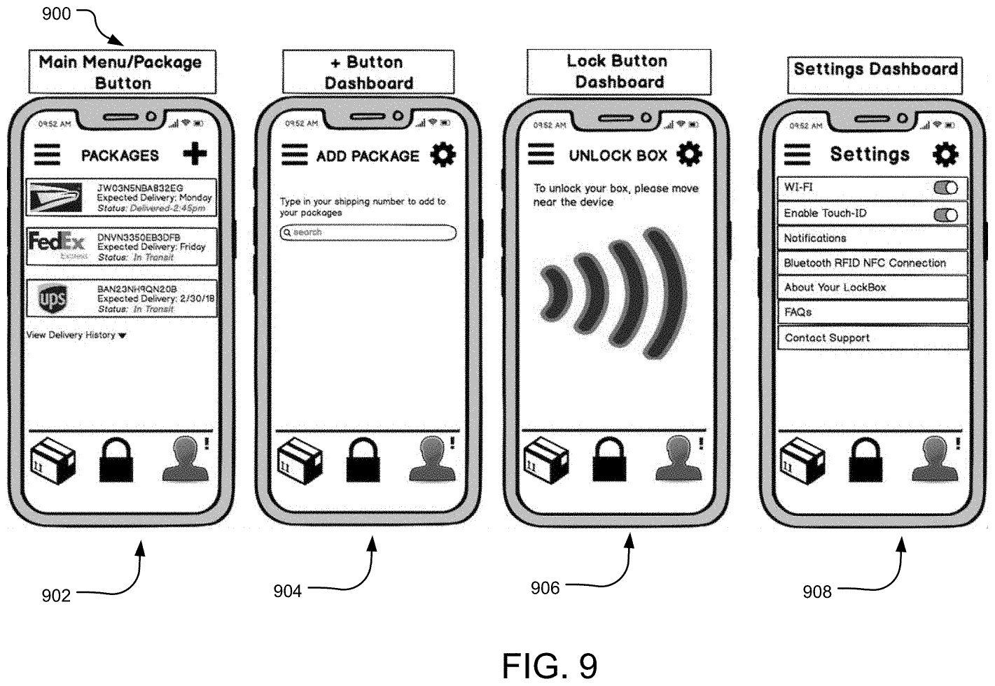

FIG. 9 illustrates a screen shot of various GUIs 900 for using the application disclosed herein. Specifically, GUI 902 discloses a main menu where the user can select which delivery service is expected to deliver a package to the secure container. In one implementation, this GUI 902 allows the user to register with each of these delivery services so that they can share tracking information with the app as necessary regarding upcoming deliveries. The user may use the GUI 904 to add a package for tracking and reception by the secure delivery container. Specifically, the user may add a package by typing in their shipping number as provided by the shipper, such an ecommerce company.

The GUI 906 may be used to lock or unlock the secure delivery container. The user may move the mobile device with the app near the secure shipping container for it to communicate with the secure shipping container. For example, such communication may be initiated automatically when the device is within a pre-determined range and may be over a Bluetooth communication channel. Alternatively, the app may generate a message to the user that the secure delivery container is nearby and by pressing a button the communication between the device with the app and the secure delivery container may be initiated. The GUI 908 provides a settings dashboard for the app to be initiated to communicate with the secure delivery container.

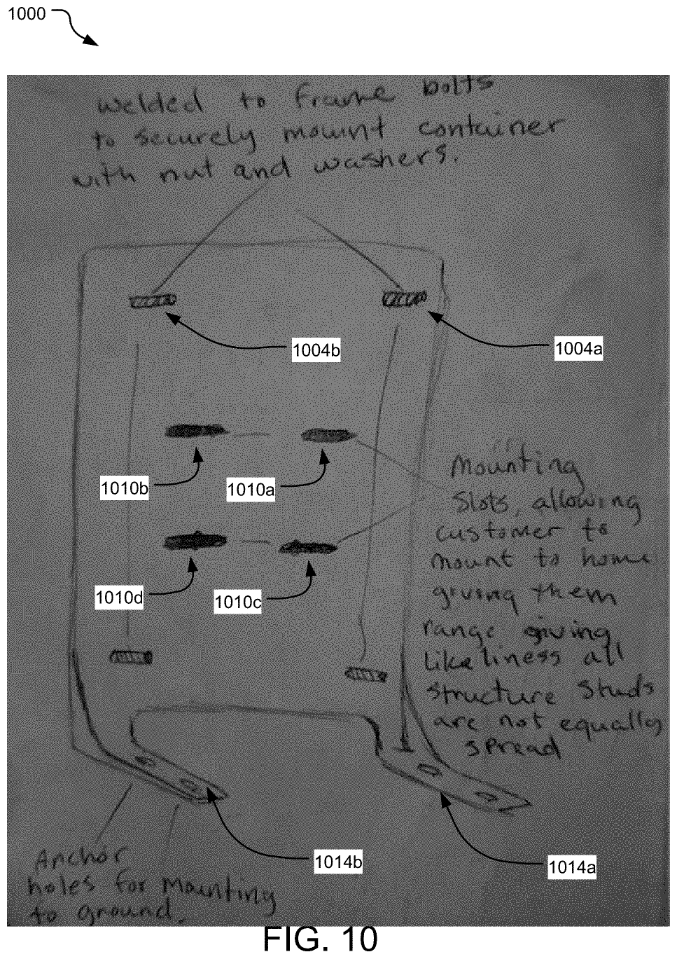

FIG. 10 illustrates an alternative mounting bracket design 1000 of the container disclosed herein. Specifically, FIG. 10 illustrates a front view of the shipping container mounting bracket 1000 with arrangements to mount or attach the container. As per this design the container includes wedding brackets 1004a and 1004b that may be welded to frame bolts to securely mount the container with nuts and washers. The front surface of the shipping container mounting bracket 1000 may also include a plurality of (in this implementation—four) mounting slots 1010a-1010d that allow a user to mount the secure delivery container to the mounting bracket 1000. In such an implementation, the secure delivery container may be provided hooks or other structure that can be attached to the mounting slots 1010a-d.

The bottom of the mounting bracket includes legs 1014a and 1014b that may be mounted to ground using anchor holes provided therein. A user may install the mounting bracket against a wall in the porch of a house such that the front surface of the mounting bracket faces the porch and a shipping container may be removably attached to the mounting bracket using the mounting slots 1010a-1010d.

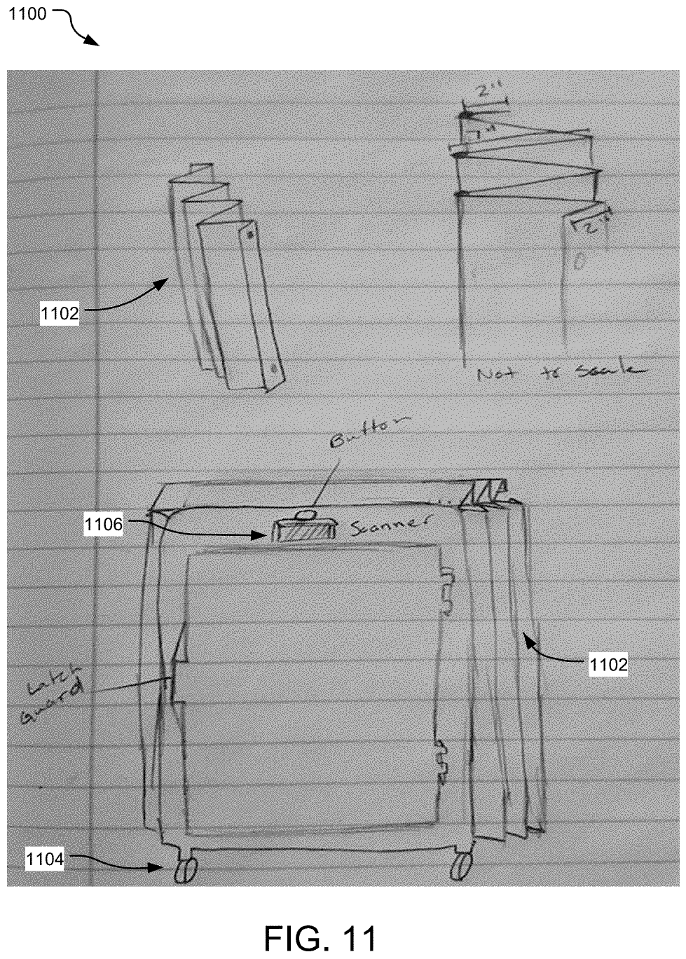

FIG. 11 illustrates an alternative accordion style design of a secure delivery container 1100 disclosed herein. Specifically, in this implementation, the secure delivery container 1100 includes according style sides 1102 that allows the secure delivery container 1100 to be collapsed again a wall of the porch, a front door, or other surface in a manner so that the secure delivery container 1100 is not obtrusive. The wheels 1104 allows the secure delivery container 1100 to be foldably contract or expand against the surface that it is installed on. A scanner 1106 on the front of the secure delivery container 1100 can be used to open the secure delivery container 1100 to deliver a delivered product.

FIG. 12 illustrates an example system 1200 that may be useful in implementing the image rendition system disclosed herein. The example hardware and operating environment of FIG. 12 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 12, for example, the computer 20 includes a processing unit 21, a system memory 22, and a system bus 23 that operatively couples various system components including the system memory to the processing unit 21. There may be only one or there may be more than one processing unit 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

In the example implementation of the computing system 1200, the computer 20 also includes a secure container communication (SCC) module 750 providing one or more functions of the secure container system disclosed herein. The system bus 23 may be any of several types of bus structures including a memory bus or memory controller, a peripheral bus, a switched fabric, point-to-point connections, and a local bus using any of a variety of bus architectures. The system memory may also be referred to as simply the memory and includes read-only memory (ROM) 24 and random-access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement an SCC system, such as an SCC system as illustrated herein. In one implementation various programs and data regarding the deliveries may be stored in memory of the computer 20, such as the read-only memory (ROM) 24 and random-access memory (RAM) 25, etc.

Furthermore, instructions stored on the memory of the computer 20 may be used by a system for generating informed join recommendations. Similarly, instructions stored on the memory of the computer 20 may also be used to implement one or more operations of an informed join recommendation system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide nonvolatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device or other common network node, and typically includes many or all of the elements described above relative to the computer 20. The logical connections depicted in FIG. 5 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software or firmware instructions for generating informed join recommendations may be stored in system memory 22 and/or storage devices 29 or 31 and processed by the processing unit 21. Mapping data and/or layer prioritization scheme data may be stored in system memory 22 and/or storage devices 29 or 31 as persistent data-stores. The SCC module 850 communicatively connected with the processing unit 21 and the memory 22 may enable one or more of the capabilities of the secure container system disclosed herein.

In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

FIG. 13 illustrates another example system (labeled as a mobile device 1300) that may be useful in implementing the described technology. The mobile device 1300 includes a processor 1302, a memory 1304, a display 1306 (e.g., a touchscreen display), and other interfaces 1308 (e.g., a keyboard). The memory 1304 generally includes both volatile memory (e.g., RAM) and non-volatile memory (e.g., flash memory). An operating system 1310, such as the Microsoft Windows® Phone operating system, resides in the memory 1304 and is executed by the processor 1302, although it should be understood that other operating systems may be employed.

One or more application programs 1312 are loaded in the memory 1304 and executed on the operating system 1310 by the processor 1302. Examples of applications 1312 include without limitation email programs, scheduling programs, personal information managers, Internet browsing programs, multimedia player applications, etc. A notification manager 1314 is also loaded in the memory 1304 and is executed by the processor 1302 to present notifications to the user. For example, when a promotion is triggered and presented to the shopper, the notification manager 1314 can cause the mobile device 1300 to beep or vibrate (via the vibration device 1318) and display the promotion on the display 1306.

The mobile device 1300 includes a power supply 1316, which is powered by one or more batteries or other power sources and which provides power to other components of the mobile device 1300. The power supply 1316 may also be connected to an external power source that overrides or recharges the built-in batteries or other power sources.

The mobile device 1300 includes one or more communication transceivers 1330 to provide network connectivity (e.g., mobile phone network, Wi-Fi®, BlueTooth®, etc.). The mobile device 1300 also includes various other components, such as a positioning system 1320 (e.g., a global positioning satellite transceiver), one or more accelerometers 1322, one or more cameras 1324, an audio interface 1326 (e.g., a microphone, an audio amplifier and speaker and/or audio jack), and additional storage 1328. Other configurations may also be employed.

In an example implementation, a mobile operating system, various applications, and other modules and services may be embodied by instructions stored in memory 1304 and/or storage devices 1328 and processed by the processing unit 1302. User preferences, service options, and other data may be stored in memory 1304 and/or storage devices 1328 as persistent datastores. A SCC module 1350 communicatively connected with the processor 1302 and the memory 1304 may enable one or more of the capabilities of the personalized user experience delivery system disclosed herein.

The informed join recommendation system disclosed herein provides solution to a technological problem necessitated by information overload and network traffic congestion resulting from excessive use of information delivered by various sources. Specifically, the informed join recommendation system disclosed herein provides an unconventional technical solution to this technological problem by analyzing the information dissemination activity of the information source over a predetermined time period to determine an activity level of the information source and providing a user the activity grade of the information source in response to a request from the user to join the information source.

A method disclosed herein includes monitoring information dissemination activity of an information source over a predetermined time period, analyzing the information dissemination activity of the information source over the predetermined time period to determine an activity level of the information source, determining an activity grade of the information source based on the activity level, receiving a request from a user to join the information source, and in response to the request from the user to join the information source, providing the user the activity grade of the information source.

In one implementation, the method includes receiving from the user a user activity grade preference and restricting the user's options to join information sources to information sources with activity grade below the user activity grade preference. Alternatively, the method also includes analyzing the user's past activity related to various information sources to determine a user activity grade preference of the user and restricting the user's options to join information sources to information sources with activity grade below the user activity grade preference. In another implementation, the method also includes receiving from the user a user activity grade preference and restricting information submissions from information sources with current activity grade above the user activity grade preference.

In one implementation, the information source is a blog and the information dissemination activity include blog entries by various members of the blog. In another implementation, the information source is a social network member and the information dissemination activity includes social network postings by the social network member. In yet another implementation, the information source is an email subscription service and the information dissemination activity include emails sent by the email subscription service. In another implementation, the information source is a news source and the information dissemination activity include news alerts delivered on a mobile device.

Alternatively, determining an activity grade for the information source further comprises determining an activity grade for the information source based on average length of information postings submitted by the information source. Yet alternatively, determining an activity grade for the information source further comprises determining an activity grade for the information source based on quality of information postings submitted by the information source.

A physical article of manufacture including one or more tangible computer-readable storage media, encoding computer-executable instructions for executing on a computer system a computer process, wherein the computer process includes analyzing the information dissemination activity of an information source over a predetermined time period to determine an activity level of the information source; determining an activity grade of the information source based on the activity level; receiving a request from a user to join the information source; and in response to the request from the user to join the information source, providing the user the activity grade of the information source.

In one implementation, the computer-executable instructions further include receiving from the user a user activity grade preference and restricting the user's options to join information sources to information sources with activity grade below the user activity grade preference. In another implementation, the computer executable instructions further include analyzing the user's past activity related to various information sources to determine the user activity grade preference of the user. In yet another implementation, the computer executable instructions further include determining the activity grade for the information source based on the quality of past activity by the information source. In one implementation, the information source is one of a blog, an email subscription service, a social network member, and a news source. Alternatively, the information dissemination activity is one of a blog entry, a social network posting, an email, and a news alert.

A system for providing informed join recommendations includes memory; one or more processor units; one more information sources configured to allow one or more users to register for information updates; and an informed join recommendation (IJR) module stored in the memory and executable by the one or more processor units, the IJR module configured to analyze the information dissemination activity of the information sources over a predetermined time period to determine an activity levels of the information sources, determine activity grades of the information sources based on the activity levels, receive a request from a user to join one of the information sources, and in response to the request from the user to join one of the information source, provide the user the activity grade of the one of the information sources.

In one implementation, the IJR module is further configured to receive from the user a user activity grade preference and to restrict the user's options to join information sources to information sources with activity grade below the user activity grade preference. In another implementation, the IJR module is further configured to analyze the user's past activity related to various information sources to determine the user activity grade preference of the user. Alternatively, the IJR module is further configured to determine the activity grade for the information source based on the quality of past activity by the information source.

The above specification, examples, and data provide a complete description of the structure and use of exemplary embodiments of the invention. Since many implementations of the invention can be made without departing from the spirit and scope of the invention, the invention resides in the claims hereinafter appended. Furthermore, structural features of the different embodiments may be combined in yet another implementation without departing from the recited claims.

What is claimed is:

1. A method comprising:
communicating one or more information about a consumer's online purchased item to a communication module of a secure container configured to accept deliveries;
scanning an identifier on a delivery package using a scanner of the of secure container;
opening the secure container in response to verifying that the scanned identifier is related to the purchased item;
accepting the delivery of the purchased item in the secure container; and
automatically closing the secure container after a predetermined time-period after accepting the delivery.

2. The method of claim 1, further comprising communicating a secure receipt message to at least one of the consumer's mobile device, an application on the consumer's mobile device, an application server of the online seller, and an application server of the delivery company.

3. The method of claim 1, wherein scanning the identifier further comprising scanning a barcode on the delivery package.

4. The method of claim 1, wherein scanning the identifier further comprising scanning a QR code on the delivery package.

5. The method of claim 1, further comprising activating the scanner in response to pressing an activation button on the secure container.

6. The method of claim 1, further comprising activating a camera of the secure container in response to completion of a delivery of a package.

7. The method of claim 2, further comprising:
receiving a request from the consumer to view the package; and
in response to the request, activating a camera on the secure container, taking a picture of the package inside the secure container; and
communicating the picture of the package to the consumer.

8. The method of claim 2, further comprising measuring the temperature of the secure container and communicating the temperature to the consumer.

9. The method of claim 8, wherein measuring the temperature of the secure container further comprises measuring the temperature of the secure container at predetermined intervals in response to a setting from consumer.

10. A secure container configured to receive a delivery package, the secure container comprising:
a wireless receiver to receive a communication including information about an expected delivery package;
a memory to store the information about the expected delivery package;
a scanner to scan an identifier on a delivery package;
a processor configured to compare the scanned identifier with information about an expected delivery package to determine if scanned identifier matches the expected delivery package, and in response, opening the secure container for a predetermined amount of time to receive the package; and
a wireless transmitter configured to transmit a secure receipt message to at least one of the consumer's mobile device, an application on the consumer's mobile device, an application server of the online seller, and an application server of the delivery company.

11. The secure container of claim 10, further comprising a camera configured to take an image inside the secure container and communicate the image to the consumer.

12. The secure container of claim 11, wherein the camera is further configured to be activated in response to a request from the consumer's mobile device to take the picture.

13. The secure container of claim 10, further comprising a temperature sensor to measure the temperature inside the secure container.

14. The secure container of claim 13, wherein the temperature sensor further configured to measure the temperature inside the secure container in response to a communication from the consumer's mobile device.

15. The secure container of claim 10, wherein the secure container is configured to have accordion style walls that are configured to collapse against a wall on which the secure container is installed.

16. The secure container of claim 10, further comprising a locking mechanism that is configured to lock the secure container in response to scanning of an unexpected identifier by the scanner.

17. A secure delivery system, comprising:
a secure container comprising:
a wireless receiver to receive a communication including information about an expected delivery package,
a memory to store the information about the expected delivery package,
a scanner to scan an identifier on a delivery package,
a processor configured to compare the scanned identifier with information about an expected delivery package to determine if scanned identifier matches the expected delivery package, and in response, opening the secure container for a predetermined amount of time to receive the package, and
a wireless transmitter configured to transmit a secure receipt message to at least one of the consumer's mobile device, an application on the consumer's mobile device, an application server of the online seller, and an application server of the delivery company, and
an app server configured to communicate with the secure container.

18. The secure delivery system of claim 17, further comprising an application configured to run on the consumer's mobile device.

19. The secure delivery system of claim 17, wherein the secure container further comprising an internal camera to take images of the delivered package.

20. The delivery system of claim 17, wherein the secure container further comprising an internal temperature to measure internal temperature of the secure container.
